(19) United States
(12) Patent Application Publication
(10) Pub. No.: US 2018/0178151 A1
(43) Pub. Date: Jun. 28, 2018

(54) SAND SEPARATOR

(71) Applicant: PRIDE OF THE HILLS MANUFACTURING, INC., Big Prairie, OH (US)

(72) Inventors: Curtis W. Murray, SR., Big Prairie, OH (US); Curtis W. Murray, JR., Wooster, OH (US); Leroy P. Whited, Elyria, OH (US)

(73) Assignee: PRIDE OF THE HILLS MANUFACTURING, INC.

(21) Appl. No.: 15/391,012

(22) Filed: Dec. 27, 2016

(51) Int. Cl. B01D 45/08; B01D 45/12; E21B 43/34

(52) U.S. Cl. CPC B01D 45/08; E21B 43/34; B01D 45/12

(57) ABSTRACT

A sand separator for a fossil fuel processing facility is provided. The sand separator includes an inlet carrying a fluid mixture of liquid water, gaseous fossil fuel, and sand. The inlet is positioned in such a way that the fluid mixture enters the internal containing volume of the sand separator in a tangential direction relative to the inner surface. The tangentially moving fluid mixture spirals downwardly to enable the gaseous fossil fuel to separate from the sand and liquid water.

### BACKGROUND

### Technical Field

The present disclosure relates generally to fossil fuel processing devices. More particularly, the present disclosure relates generally to a sand separator. Specifically, the present disclosure relates to a sand separator having components configured in a particular way to efficiently separate sand from fossil fuel and fluid.

### Background Information

A separator in the oil/gas industry is a pressure vessel used for separating a well stream into solid, liquid, and gaseous components. Typically, one or more separators are installed at fossil fuel processing stations or locations. Based on the separator vessel configurations, the separators can be divided into horizontal, vertical, or spherical separators.

Sand separators are a specific type of separator that separate sand components (as well as other solids) from the well stream moving through the sand separators. Some conventionally known sand separators utilize a vertically aligned cylindrical vessel to allow the solids (i.e., the sand) to fall to the bottom of the vessel under gravitational forces when the well stream is injected into the vertically aligned sand separator.

### SUMMARY

Issues continue to exist with vertically aligned sand separators. Particularly, when the well stream carrying solid, liquid, and gaseous components is fed into the sand separators, it can take some time for the sand components (and other solid components) to separate themselves from the fluid and gaseous components. Thus, a need continues to exist for an improved sand separator that separates solids from liquids and gaseous components in a well stream in a faster and more efficient manner. The present disclosure addresses these and other issues.

In accordance with one aspect, an embodiment of the present disclosure may provide a sand separator for fossil fuel processing comprising: an elongated cylindrical body extending centrally along a longitudinal axis; an outer surface and inner surface on the cylindrical body, wherein the inner surface defines a containing volume; a sand containment area associated with one end of the containing volume; an inlet aligned tangentially relative to the inner surface and the inlet in fluid communication with the containing volume such that a fluid mixture moving through the inlet carrying fossil fuel enters the interior cavity moving in a tangential direction relative to the inner surface.

In accordance with another aspect, an embodiment of the present disclosure may provide a method of separating sand from gaseous fossil fuel in a sand separator comprising the steps of: moving a fluid mixture comprising a fossil fuel, sand, and a liquid along a pipeline towards a sand separator including an arcuate inner surface defining a containing volume; effecting the fluid mixture to enter the containing volume at a tangential direction relative to the inner surface; and spiraling the liquid and sand downwardly along the inner surface and simultaneously releasing fossil fuel upwardly in a substantially gaseous state.

In accordance with another aspect, an embodiment may provide a sand separator for a fossil fuel processing facility. The sand separator includes an inlet carrying a fluid mixture of liquid water, gaseous fossil fuel, and sand. The inlet is positioned in such a way that the fluid mixture enters the internal containing volume of the sand separator in a tangential direction relative to the inner surface. The tangentially moving fluid mixture spirals downwardly to enable the gaseous fossil fuel to separate from the sand and liquid water.

In accordance with another aspect, an embodiment may provide a sand separator for fossil fuel processing comprising: an elongated cylindrical body extending centrally along a longitudinal axis and wherein the longitudinal axis is aligned directly vertical; an outer surface and inner surface, wherein the inner surface defines a containing volume; an inlet in fluid communication with the containing volume, the inlet position adjacent an upper end of the cylindrical body having a fluid mixture flow therethrough into the containing volume, wherein the fluid mixture includes gaseous fossil fuel, liquid water, and sand; a first rigid member secured to the inner surface and extending inwardly towards the longitudinal axis, wherein the first rigid member is an arcuate plate having first and second surfaces and the first surface having a radius of curvature complementary to that of the inner surface, and having a lower terminal edge; the first rigid member positioned adjacent the inlet such that fluid carrying fossil fuel through the inlet contacts the first rigid member before contacting the inner surface; wherein the inlet is offset from the longitudinal axis and tangentially aligned with the inner surface such that fluid moving through the inlet and contacting the first rigid member moves in a spiraling manner about the longitudinal axis while moving along the inner surface and simultaneously being drawn downward under gravitational forces; a gas outlet in fluid communication with the containing volume adjacent its top and configured to release the gaseous fossil fuel, wherein the gas outlet positioned above the inlet; a fluid outlet disposed within the containing volume, wherein the fluid outlet enables fluid to raise upwardly in the containing volume and exit the fluid outlet to drain through a pipe after the fluid has been separated from the sand; a sand containment area defining a bottom of the containing volume; a sand outlet in fluid communication with the sand containment area configured to drain sand from the bottom of the containing volume after the sand has been separated from the gaseous fossil fuel and the liquid water; a recombination area defied by a combining junction exterior to the cylindrical body fluidly connected with the fluid outlet and the gas outlet combining gaseous fossil fuel with liquid water.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a schematic view of a fossil fuel processing system incorporating a sand separator of the present disclosure;

FIG. 2 is a side elevational view of the sand separator of the present disclosure;

FIG. 3 is a top plan view of the sand separator taken along line 3-3 in FIG. 2;

FIG. 4 is an elevational cross-section of the sand separator taken along line 4-4 in FIG. 3;

FIG. 4A is an enlarged cross-section view of the area labeled “See FIG. 4A” in FIG. 4;

FIG. 5 is an elevational cross-section view taken along line 5-5 in FIG. 3 and orthogonal to line 4-4 in FIG. 3;

FIG. 6 is a transverse cross-section view taken along line 6-6 in FIG. 2;

FIG. 7 is a transverse cross-section view taken along line 7-7 in FIG. 2;

FIG. 8 is a transverse cross-section view taken along line 8-8 in FIG. 2;

FIG. 9 is an elevational cross-section view depicting the operational movement and separation of sand from fluid and gaseous fossil fuel in the sand separator;

FIG. 9A is an enlarged operational view of the region labeled “See FIG. 9A” in FIG. 9;

FIG. 10 is a second embodiment of the sand separator in accordance with the present disclosure including two outlets that do not combine downstream from the second embodiment sand separator;

FIG. 11 is a side elevational cross section view of a third embodiment of the sand separator in accordance with the present disclosure including an outlet that has an uptake tube supported by baffles; and

FIG. 12 is a cross section view taken along line 12-12 in FIG. 11 depicting the third embodiment having four baffles supporting a vertically centered uptake tube.

Similar numbers refer to similar parts throughout the drawings.

### DETAILED DESCRIPTION

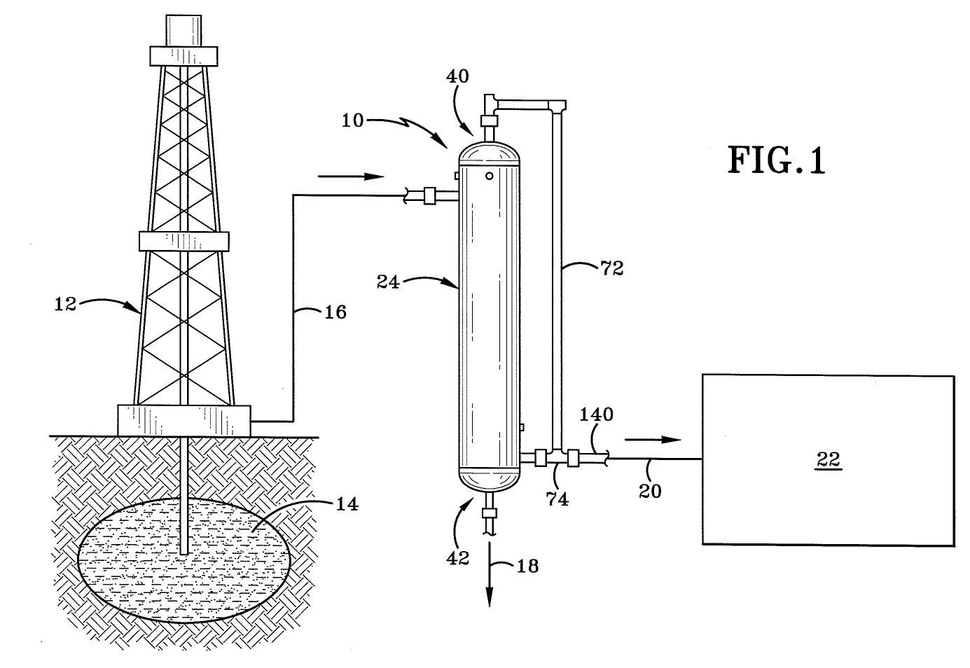

As depicted in FIG. 1, the sand separator of the present disclosure is shown generally at 10. Sand separator 10 is installed as a portion of a fossil fuel processing system including a gas well 12 configured to pump fossil fuel 14 along a first line 16 operatively connected with sand separator 10. Sand separator 10 is configured to separate sands from the fuel stream thereby outputting sand along line 18 and fuel along outlet line 20 where the fuel then proceeds to a downstream destination 22. Sometimes fuel may be remixed with fluid separated from the sand.

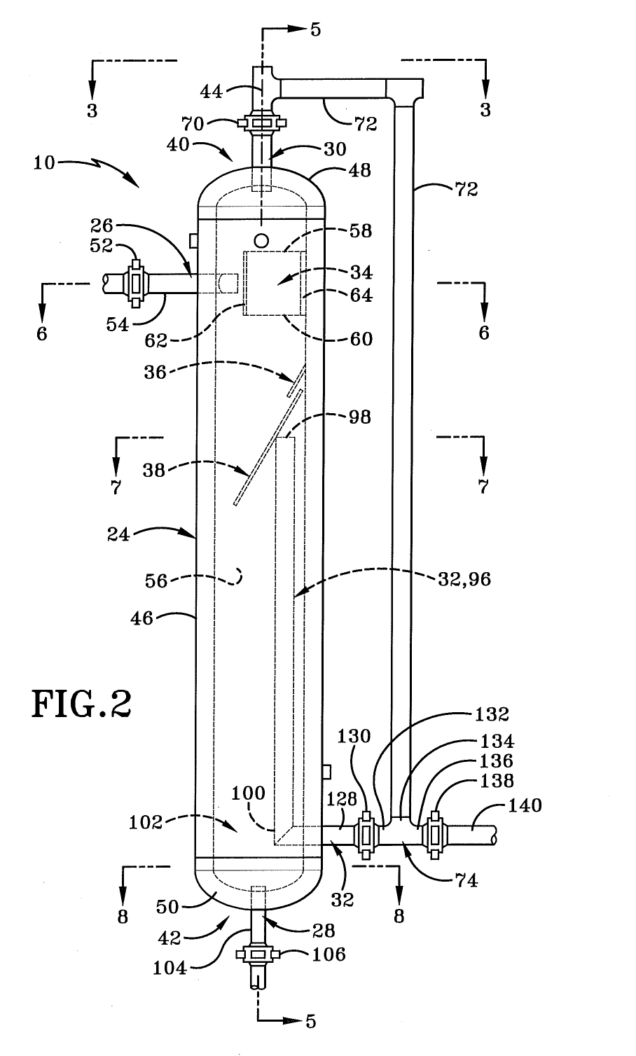

As depicted in FIG. 2, sand separator 10 may include a hollow cylindrical vessel 24, an inlet 26, a sand outlet 28, a gaseous fuel carrying first outlet 30, a fluid carrying second outlet 32, an arcuate first plate 34, a smaller parabolic second plate 36, and a larger parabolic third plate 38.

Separator 10 includes a first end 40 spaced opposite a second end 42 defining a longitudinal axis 44 therebetween. For the purpose of this disclosure, some components of sand separator 10 will be made with reference to first end 40, second end 42, or relative to the longitudinal axis 44. For example, some components may be closer to the first end 40 and other components may be closer to the second end 42. Additionally, other components may be partially arcuate or circular such that they are positioned radially relative to longitudinal axis 44.

Vessel 24 is a substantially rigid unibody member formed from a cylindrical sidewall 46 having an outer surface and an inner surface and capped at each end with rigid hemispherical sections. Particularly, a first hemispherical member 48 may be associated with the first end 40 of sand separator 10 and a second hemispherical endcap 50 is connected to cylindrical sidewall 46 and is associated with second end 42 of sand separator 10.

In some implementations, sand separator 10 is vertically aligned such that longitudinal axis 44 is arranged directly vertical and the first end 40 is above the second end 42. Thus, while it is not intended to be limiting, some aspects of this disclosure may make reference to first end 40 as being “the top end” and second end 42 as being “the bottom end.” When sand separator 10 is vertically aligned, gravitational forces may be utilized during the sand separation process as will be described in greater detail below.

With continued reference to FIG. 2 and the vertical alignment of sand separator 10, the inlet 26 is positioned vertically below gaseous fuel carrying first outlet 30. First inlet 26 may include a valve 52 fluidly connected to vessel 24 exterior to the outer surface, and more particularly, in open fluid communication with an internal volume 56 collectively defined by the cylindrical sidewall 46, the first hemispherical endcap 48, and the second hemispherical endcap 50.

Arcuate plate 34 includes a top first edge 58 spaced apart and opposite a bottom second edge 60. Additionally, plate 34 includes a first side edge 62 and second side edge 64. The terminal end of inlet piping 54 is vertically between top edge 58 and bottom edge 60. The terminal end of inlet piping 54 is positioned offset from first edge 62. In other instances, piping 54 is above bottom edge 60. The terminal end of inlet piping 54 and the bottom edge 60 of arcuate plate 34 are both vertically above smaller parabolic second plate 36.

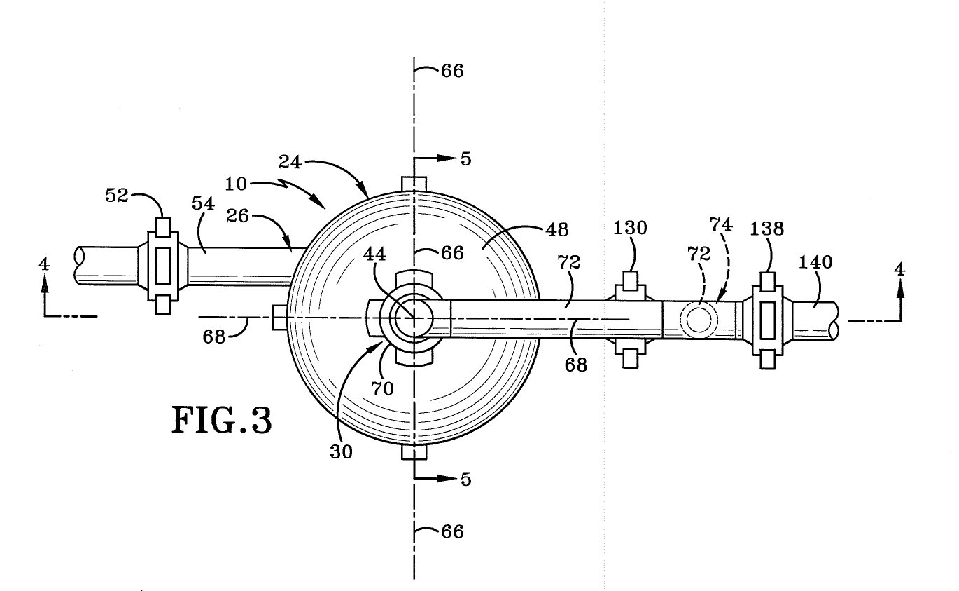

As depicted in FIG. 3, when viewing sand separator 10 from above, a pair of imaginary planes perpendicularly intersecting each other are shown in order to make reference to other components. Particularly, a transverse first plane 66 perpendicularly intersects a lateral second plane 68 at the longitudinal axis 44. Pipeline 54 is offset entirely to one side of lateral second plane 68. As represented in FIG. 3, pipeline 54 contacts cylindrical sidewall 46 and extends therethrough to create an open fluid communication with internal containing volume 56. First outlet 30 is located at the intersection of first plane 66 and second plane 68 at the top of vessel 24. First outlet 30 may include a valve 70 to selectively open and close first outlet 30. Pipeline 72 is fluidly connected with valve 70 and extends downstream to a combining junction 74. Portions of pipeline 72 are shown as lying along lateral second plane 68, however other design implementations may allow for other positions and alignments of pipeline 72 and combining junction 74.

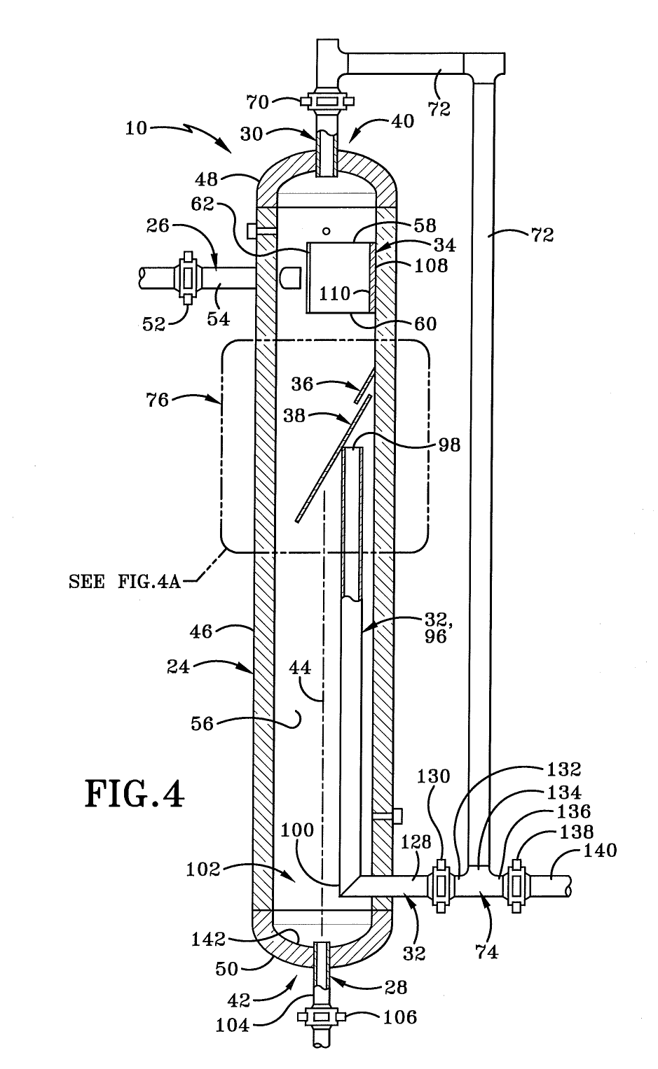

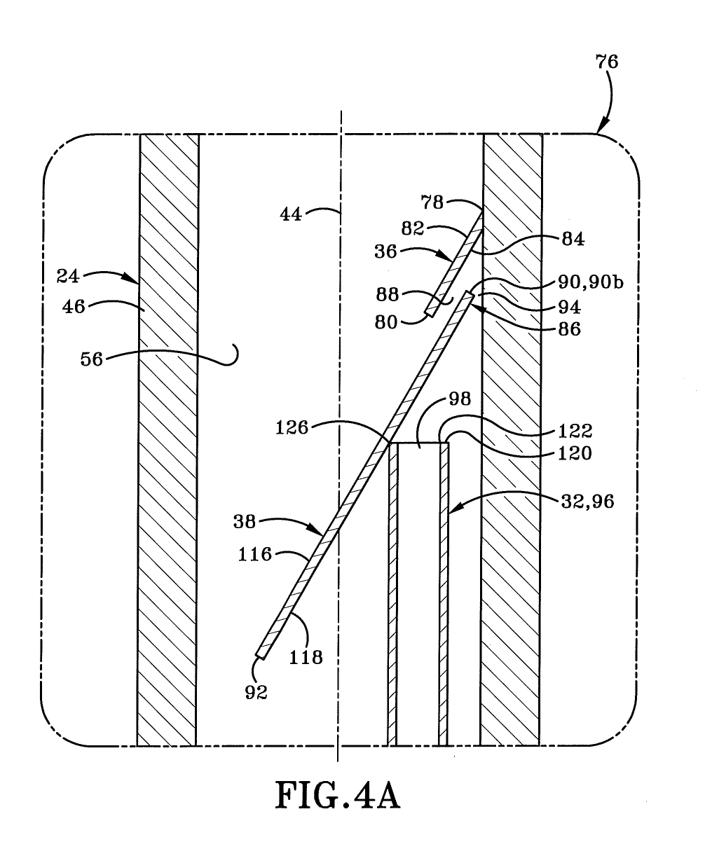

As depicted in FIG. 4 and the enlarged view FIG. 4A, a sand separation area is shown generally at 76. The smaller parabolic second plate 36 and the larger parabolic third plate 38 are within the separation area 76 inside the internal volume 56 within the inner surface of cylindrical sidewall 46. Second plate 36 includes a first edge 78 and a bottom terminal edge 80. First edge 78 is rigidly secured with the inner surface of cylindrical sidewall 46. Plate 36 includes a first surface 82 which faces longitudinal axis 44 and a second surface 84 opposite first surface 82 and faces away from longitudinal axis 44. Second plate 36 is angled relative to horizontal when viewed in cross section and in one particular embodiment is in a range from about 20° to about 80°. Specifically, another embodiment as depicted in FIG. 4A, second plate 36 is positioned at an angle of 60° relative to horizontal. Portions of third plate 38 are disposed below second plate 36. However, a small upper portion 86 of third plate 38 is vertically above bottom edge 80 of second plate 36 when viewed in cross section from the side. A gap 88 is defined between second surface 84 of second plate 36 and upper portion 86 of third plate 38. Third plate 38 includes a top edge 90 spaced opposite a bottom edge 92. Portions of top edge 90 when viewed in cross sections do not connect with the inner surface of cylindrical sidewall 46 to create a second gap 94 between the inner surface of cylindrical sidewall 46 and the disconnected portion of top edge 90. As will be described in greater detail below, when viewing third plate 38 in transverse cross section, top edge 90 is parabolically shaped and arcuate having some connecting portions along the inner surface of cylindrical sidewall 46 and other portions that are not connected to thereby define gap 94.

Third plate 38 may be angled relative to horizontal similar to that of second plate 36. Accordingly, in some implementations third plate 38 is parallel and offset from second plate 36. In these instances, the angle relative to horizontal of third plate 38 is equal to that of second plate 36. As such, third plate 38 may be angled in a range from about 20° to about 80° and in the shown embodiment is angled at 60° relative to horizontal. In other implementations, the angle of the third plate 38 is within 10° relative to the angle of the second plate 36. For example, if second plate 36 is positioned at 60° relative to horizontal, then second plate may be positioned at 50° or 70° or any angle therebetween.

With continued reference to FIG. 4A, a pipeline 96 forms a portion of second outlet 32. The outlet opening 98 formed by pipeline 96 is positioned intermediate first edge 90 and second edge 92 of third plate 38. Pipeline 96 is generally vertically aligned and offset relative to longitudinal axis 44 when viewed in cross section however, there are other implementations which may provide a scenario where pipeline 96 is concentric with longitudinal axis 44. Additionally, an upper portion of pipeline 96 may contact a surface on third plate 38 however; other embodiments may provide a pipeline 96 that is offset relative to third plate 38.

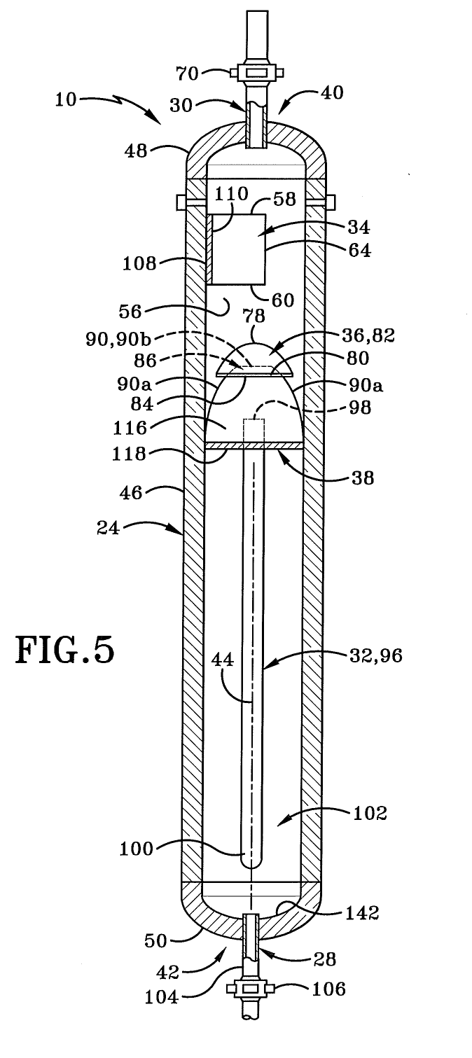

FIG. 5 more clearly depicts the parabolic shape of second plate 36 and the parabolic shape of third plate 38. Top edge 78 of plate 36 extends in an arcuate manner in continuous contact with the inner surface of cylindrical sidewall 46. As indicated previously, portions of top edge 90 on plate 38 are connected to the inner surface of cylindrical sidewall 46. The connected portions of top edge 90 are indicated as 90A and shown as a solid line. The upper most apex edge of edge 90 is not connected and is shown generally as 90B. More particularly, gap 94 is defined between the inner surface of cylindrical sidewall 46 and the disconnected portion of top edge 90B.

With continued reference to FIG. 5, pipeline 96 includes a bottom end 100 spaced opposite opening 98 beneath third plate 38. Bottom end 100 of pipeline 96 extends through the cylindrical sidewall 46 (which is shown as extending into the page in FIG. 5) such that pipeline 96 of second outlet 32 can carry fluid out of the internal volume 56 which will be described in greater detail below.

The lower end of internal volume 56 is generally considered a sand containment area 102 which is configured to receive sand as it is separated from fluid in the separation area 76, the process of which will be described in greater detail below. Sand outlet 28 is in open communication with sand containment area 102. A sand outlet pipeline 104 extends through the hemispherical second endcap 50 and is configured to move sand along. A valve 106 may be operatively connected to pipeline 104 to selectively open and close the movement of sand through pipeline 104.

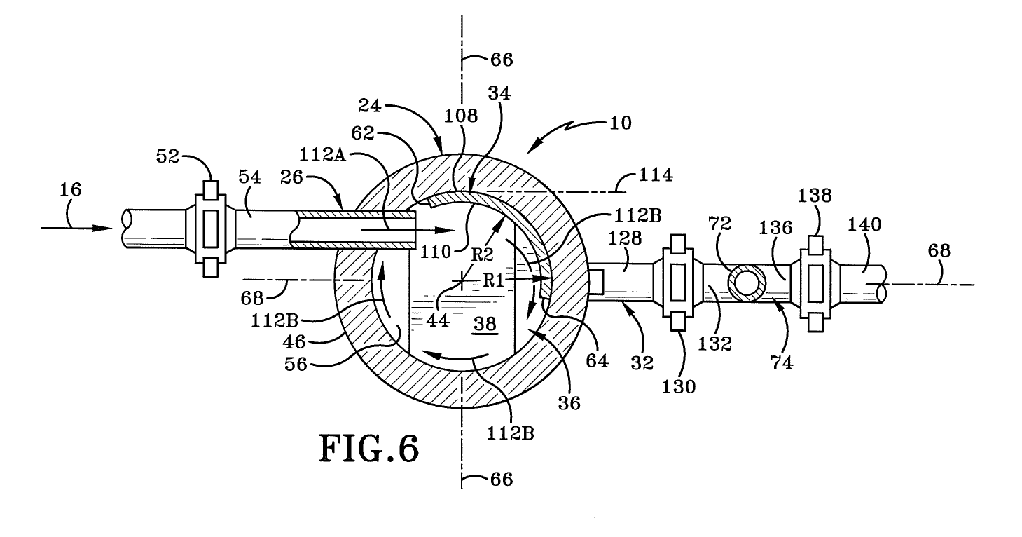

As depicted in FIG. 6, arcuate plate 34 includes a first surface 108 spaced opposite a second surface 110. A thickness of the arcuate plate is associated with the radial distance between first surface 108 and second surface 110. First surface 108 is a curved surface extending between first side edge 62 and second side edge 64. The radius of curvature associated with first surface 108 is complementary to that of the radius of curvature of the inner surface of cylindrical sidewall 46. The common radius of curvature associated with first surface 108 and the inner surface of cylindrical sidewall 46 is depicted generally as R1. A second radius of curvature associated with surface 110 is depicted generally as R2 and R2 is less than R1.

As depicted in FIG. 6, a plane 114 is a tangential plane relative to the inner surface of cylindrical sidewall 46. Tangential plane 114 is offset and parallel relative to plane 68 and orthogonal relative to plane 66. As will be described in greater detail below, some components of sand separator 10 are described in greater detail and in relation to tangential plane 114.

FIG. 6 also depicts the movement of the fuel stream moving along line 16 through the inlet 26 and into the internal containing volume 56. The directional movement of the fuel stream moving along line 16 and into internal volume 56 is generally shown at 112A. At 112A, the moving fuel stream is moving in a generally tangential path that is linearly aligned with pipe 54 and offset parallel to plane 68. Additionally, tangentially and linearly moving fuel stream 112A is parallel and offset a short distance to tangential plane 114. As the linearly moving in a tangential direction fuel stream 112A contacts second surface 110 of plate 34, the radius of curvature R2 associated with second surface 110 causes the fluid and sand mixture to move in an arcuate manner around longitudinal axis 44. The arcuately moving fluid and sand mixture is represented by arrows 112B. As shown in FIG. 6 and when viewed from above, the arcuately moving fluid and sand mixture 112B moves in a generally clockwise direction around central axis 44. As will be described in greater detail below, when viewed from a side elevation view, the arcuately moving fluid and sand mixture 112B moves around longitudinal axis 44 while being drawn downwardly under gravitational forces to thereby represent a helically winding movement of the fluid and sand stream mixture 112B.

The fuel stream 112A that is referred to as moving in a tangential direction refers to fuel, sand, and liquid moving through inlet pipe 54 that is entering internal volume 56 closely parallel to tangential plane 114. The center of fuel stream 112A is closely adjacent tangential plane 114 and is closer to plane 114 than plane 68. Fuel stream 112A contacts plate 34 before contacting inner surface of vessel 24.

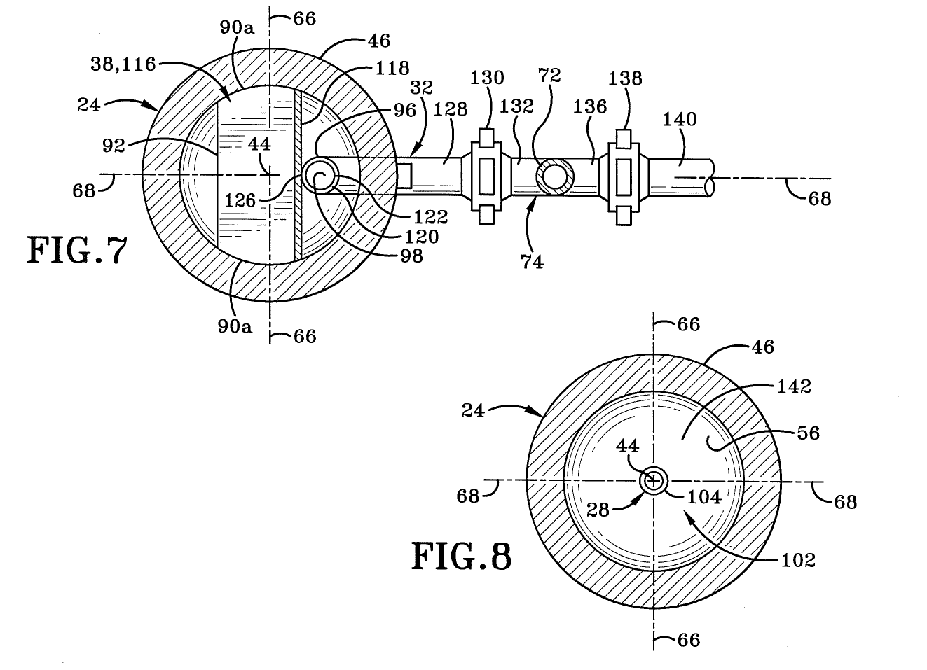

As depicted in FIG. 7, third plate 38 includes an upwardly facing top surface 116 intersecting longitudinal axis 44. The surface 116 is spaced opposite a downwardly facing bottom surface 118 (FIG. 4A) that also intersects longitudinal axis 44. When viewed from above, the bottom edge 92 of plate 38 is positioned on an opposite side of plane 66 than pipeline 96. The pipeline 96 includes an upwardly facing top rim 120 including a completely bound inner edge 122 defining the opening 98 to pipeline 96. Top rim 120 may contact second surface 118 at a junction point 126. However, it is not required that pipeline 96 contact top rim 120.

With continued reference to FIG. 7, the pipeline 96 extends vertically downward offset and parallel to longitudinal axis 44 to the bottom end 100 where the direction of pipeline 96 changes by about 90° and extends in a direction parallel to plane 68 through sidewall 46. The portion of the outlet pipe line that is extending beyond the outwardly facing outer surface of cylindrical sidewall 46 is indicated generally at 128. Outlet exterior pipe line 128 is connected to combining junction 74 via a valve 130. Outlet exterior pipe line 128 is in open fluid communication with combining area 74.

Combining junction 74 may be a T-pipeline having two inlets and one outlet. Particularly, the combining junction 74 includes a first section 132, a second section 134, and a third section 136. First section 132 of combining junction 74 is connected with valve 130 to receive fluid moving through pipeline 96. The second section 134 of combining junction 74 is fluidly connected with pipeline 72 configured to receive gaseous fuel moving through pipeline 72 into combining junction 74. Within combining junction 74, the fluid moving through section 132 and the gaseous fuel moving through section 134 combine and then flow outwardly through third section 136. The third section 136 of combining junction 74 may be considered an outlet with respect to combining junction 74. Third section 136 is fluidly connected to the combined pipeline 140 via a valve 138. The combined pipeline carries gaseous fuel combined with fluid that is free from sand which has been separated out by sand separator 10. The combined fuel pipeline 140 extends operatively downstream and may generally be referred to as fuel line 20 (see FIG. 1).

As depicted in FIG. 8, the sand containment area 102 includes an upwardly facing concave inner surface 142 when viewed from above. The outlet piping 104 for sand removal is aligned coaxially with longitudinal axis 44. The outlet piping 104 fluidly communicates with the interior volume 56 at the lowermost portion of upward facing concave surface 142.

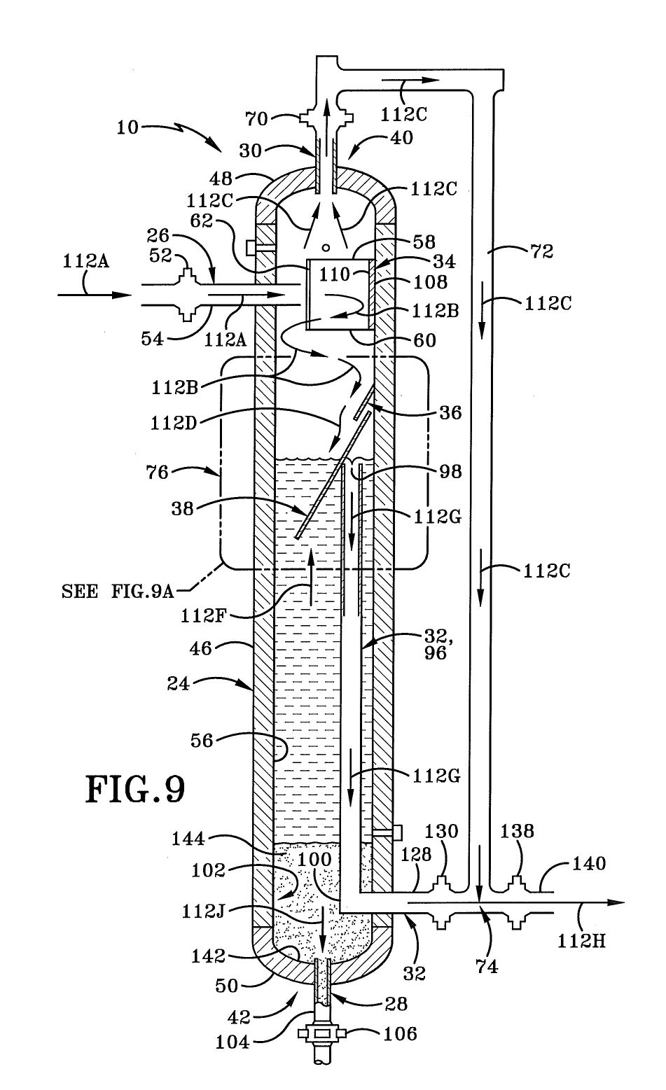

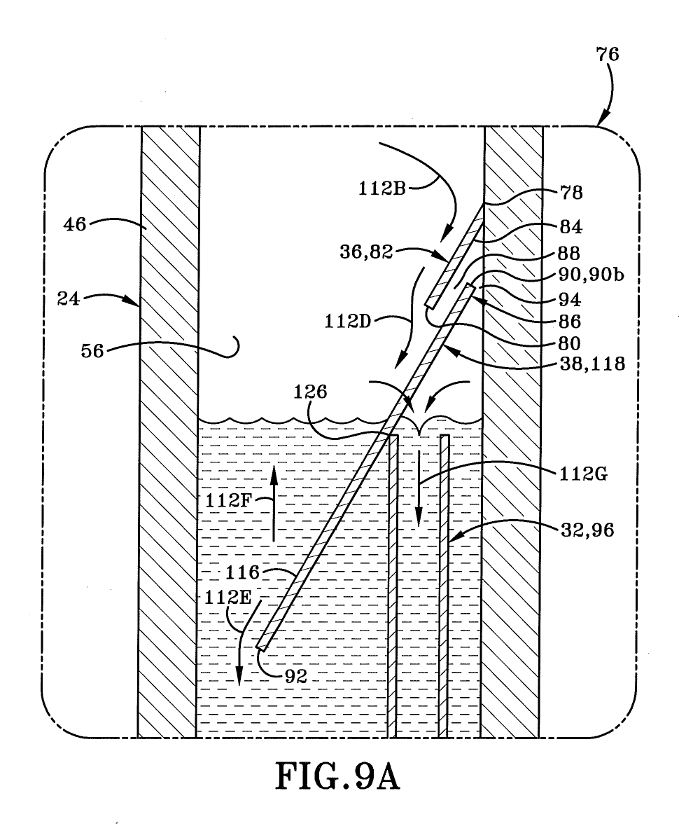

In accordance with an aspect of the present disclosure, sand separator 10 provides an improved vertically aligned and gravitationally forced sand separation unit. The configuration of the internal components of sand separator efficiently separate sand from gaseous fuel and other fluids to provide an improved gas processing assembly which is configured to be incorporated into an overall gas processing system. The operation of sand separator 10 is shown in greater detail with respect to FIG. 9 and FIG. 9A.

As depicted in FIG. 9, fuel moving towards and into sand separator 10 in a generally tangential manner is shown at 112A. The fuel at 112A is a mixture of gaseous fuel, sand, and other fluids. The fuel mixture 112A is pumped into sand separator 10 at a tangential direction generally coplanar with the tangential plane of the inner surface of cylindrical sidewall 46. As the fuel moving parallel to the tangent plane 114 contacts the arcuate plate 34, fluid and sand move in a helical manner as indicated by arrow 112B generally downward and in an arcuate manner about longitudinal axis 44. The helical movement of fluid and sand indicated by 112B enables gaseous fuel to expand and separate therefrom and move upwardly within the internal volume 56. The upwardly moving separation of gaseous fuel from the fluid and sand mixture is indicated by arrow 112C. At this point, the gaseous fuel is considered “separated” from the sand and fluid mixture moving helically downward at 112B. The separated gaseous fuel 112C moves outwardly from vessel body 24 through first outlet 30. The gaseous fuel 112C moves along pipeline 72 towards combining junction 74.

As depicted in FIG. 9A, the helically and downwardly moving fluid and sand mixture 112B contacts second plate 36 and moves along first surface 82. The fluid and sand mixture 112B flows downwardly along plate 36 towards the bottom edge 80. As the fluid and sand mixture 112B flows past bottom edge 80 of plate 36, the purposeful separation defined by gap 88 between second plate 36 and third plate 38 creates a waterfall effect which is generally indicated by the waterfall-shaped or stepped arrow 112D. The waterfall effect of the stepped relationship between the second plate 36 and third plate 38 assists in making turbulent forces of the fluid and sand mixture. The turbulent forces assist in the separation of sand from the fluid. The fluid and sand mixture continues to run downwardly along the first surface 116 of third plate 38 and vertically downward into the sand containment area 102. The downward movement of fluid and sand into the sand containment area is generally indicated at 112E. As the fluid and sand mixture move downwardly to the lower end of sand separator 10, the sand particles separate from the fluid and the sand is retained in the sand containment area 102.

The sand contained in the sand containment area 102 is indicated generally at 144 in FIG. 9. The fluid 143 separated from the sand 144 begins to rise and fill the container. The rising fluid 143 separated from the sand 144 is indicated generally at arrow 112F. Once the fluid 143 separated from the sand 144 rises in the direction of arrow 112F and is at a level vertically above opening 98, the fluid 143 begins to drain through pipeline 96 outwardly from the vessel 24 towards combining junction 74. The outwardly flowing movement of fluid 143 from the vessel 24 is indicated generally at 112G. The fluid moving in the direction of arrow 112G is combined with the gaseous fuel moving in the direction of arrow 112C at combining junction 74. Together, the gaseous fuel at 112C combines with fluid at 112G to form a combined outflow of gaseous fuel and fluid shown generally at 112H. The combined outflow 112H is free of sand 144. Combined outflow 112H may flow to downstream destination 22.

After an extended period of time, the sand 144 will eventually begin to fill the inner container volume and will need drained and removed as one having ordinary skill in the art would understand and foresee as it is the current state of the art that sand separators need to be drained for their continued use. In order to drain the sand 144, the second outlet 28 is opened via valve 106 to allow sand 144 to drain outwardly from the internal container volume via arrow 112J.

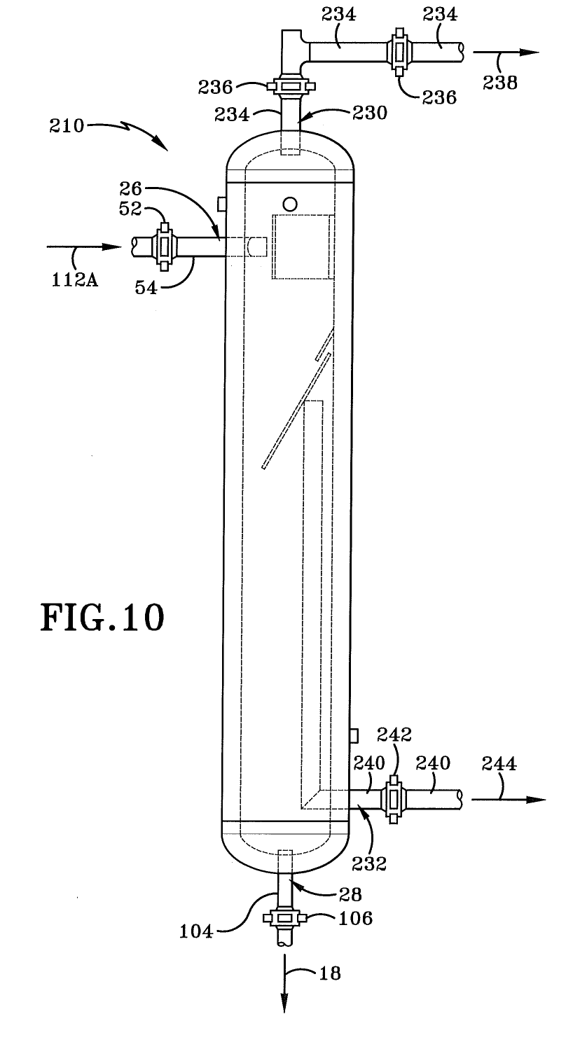

As depicted in FIG. 10, a second embodiment in accordance with the present disclosure depicts a sand separator generally as 210. Certain components of the second sand separator 210 have similar reference numerals to that of sand separator 10. Different components will be identified through distinct reference numerals.

Sand separator 210 includes a first outlet 230 and a second outlet 232. First outlet 230 is configured to permit the outflow of gaseous fuel therethrough along a pipeline 234 having one or more valves 236 interposed therealong. The gaseous fuel is then carried downstream in the direction of arrow 238 to a downstream destination distinct and separate from that of the downstream destination for the fluid exiting sand separator 210 through second outlet 232.

Second outlet 232 includes the interior portions disposed within internal cavity 56 similar to that of sand separator 10, but also includes pipeline 240 and a valve 242 extending downstream to a fluid downstream destination which is represented by arrow 244 distinct and separate from the gaseous fuel downstream destination represented by arrow 238.

Sand separator 210 would be utilized in a scenario where the gaseous fuel is processed in a separate facility or a separate gas processing stream independent from the fluid recently separated from the sand. One having ordinary skill in the art would understand and foresee that sand separator 210 free of a combining assembly or combining junction 74 would have its advantages as the gaseous fuel moving in the direction of arrow 238 could be utilized without being mixed back into a fluid mixture moving in the direction of arrow 244 which is the teaching of sand separator 10.

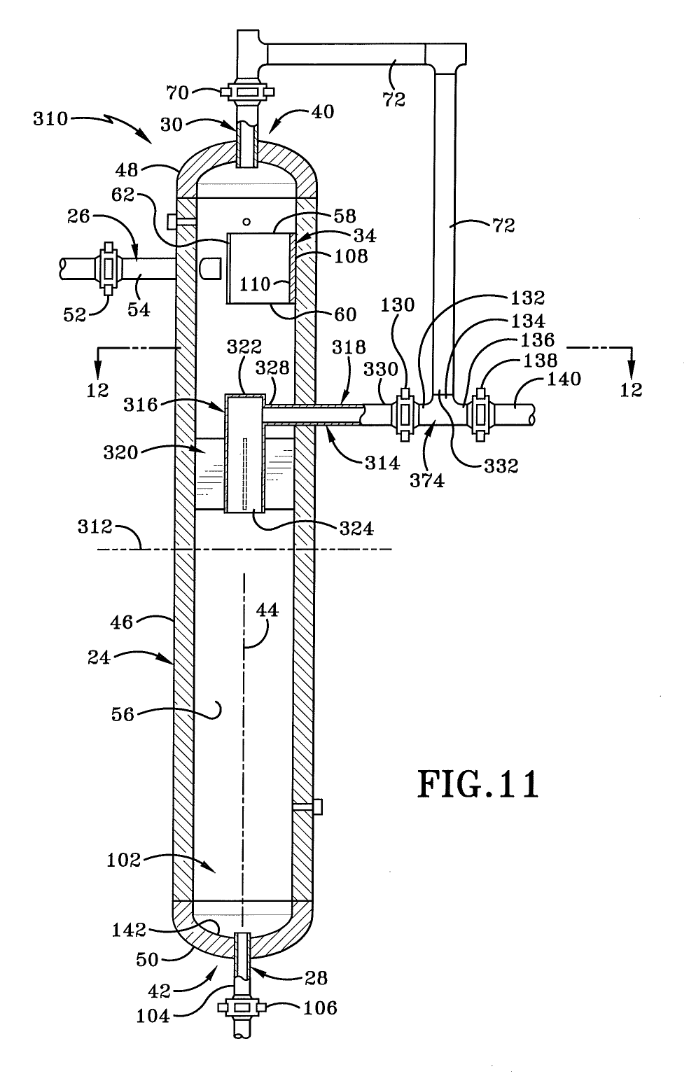

As depicted in FIG. 11, a third embodiment in accordance with the present disclosure depicts a sand separator generally at 310. Certain components of sand separator 10 have similar reference numerals to that of sand separator 10 and sand separator 210. Different components will be identified through distinct reference numerals.

Sand separator 310 includes an imaginary vertical midline 312 extending transversely to thereby divide sand separator 310 into an upper portion and a lower portion as indicated in FIG. 11.

Sand separator 310 includes a fluid outlet 314. The fluid outlet generally referred to as outlet 314 is formed from a plurality of components, namely, an outlet uptake tube 316, a discharge outlet pipeline 318, and one or more baffles 320.

Uptake tube 316 includes an upwardly facing top end 322 spaced apart from a bottom opening 324. The top 322 of uptake tube 316 is positioned vertically above outlet piping 318. The bottom opening 324 of uptake tube 316 is positioned vertically above vertical midline 312. While the bottom opening 324 of uptake tube 316 is depicted as being positioned vertically above vertical midline 312, other embodiments are entirely possible that would provide the bottom opening 324 of uptake tube 316 being positioned and disposed in the lower half of sand separator 310.

Vertical uptake tube 316 is concentric with vertically aligned longitudinal axis 44 such that uptake tube 316 is positioned in the center of the interior cavity volume 56. Uptake tube 316 is a substantially rigid member having a single exit in open fluid communication with outlet piping 318 adjacent top end 322. As will be described in greater detail below, fluid is configured to move upwardly through the center of uptake tube 316 through bottom opening 324 and out of uptake tube 316 along pipeline 318 towards the combining junction 74.

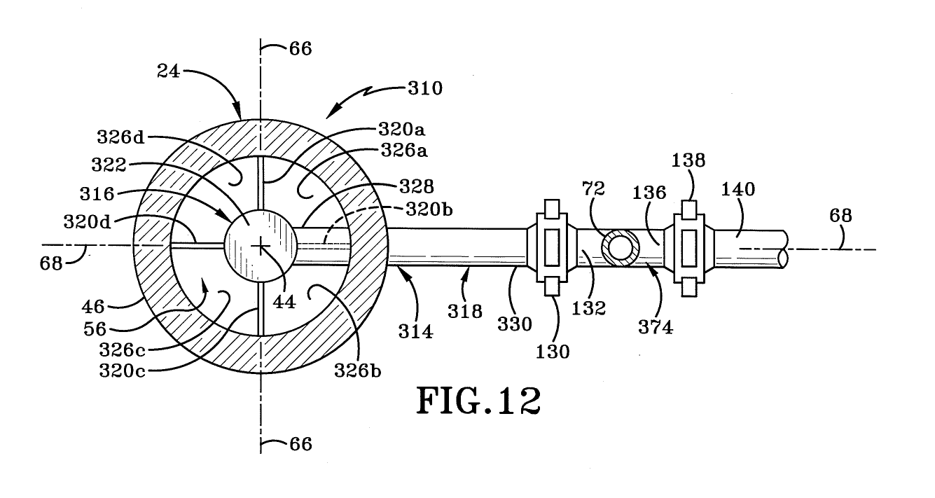

As depicted in FIG. 11 and FIG. 12, uptake tube 316 is held centrally in place via a rigid connection with one or more baffles 320. The baffles 320 extend between the outer surface of tube 316 and the inner surface of cylindrical sidewall 46 defining interior cavity volume 56. In one particular embodiment, a first baffle 320a, a second baffle 320b, a third baffle 320c, and a fourth baffle 320d are provided. The first baffle 320a and the third baffle 320c are positioned coplanar such that they lie along plane 66. First baffle 320a is offset entirely to one side of plane 68 opposite that of third baffle 320c which is offset to the other side of plane 68. Second baffle 320b and fourth baffle 320d are oriented coplanar along plane 68. The second baffle 320b is offset entirely to one side of plane 66 opposite that of fourth baffle 320d. Essentially, this embodiment may divide interior chamber 56 into four baffle quadrants. Namely, the four baffle quadrants are represented as first baffle quadrant 326a, second baffle quadrant 326b, third baffle quadrant 326c, and fourth baffle quadrant 326d. The angular intervals at which the first through fourth baffles are positioned may be equal, as shown, or other embodiments may provide an irregular positioning of the respective baffles. Additionally, while four baffles are depicted in FIG. 11, it is to be well understood that an alternative number of baffles may be utilized to accomplish similar objectives of the four baffles described above. For example, separator 310 may have only one baffle, may have two baffles, may have three baffles, may have five baffles, may have six baffles, may have seven baffles, or may have eight baffles or more. Furthermore, the baffles need not be evenly spaced as depicted in FIG. 11. There may be instances where the intervals between the baffles (i.e., the baffle quadrants) are sized differently, or where the first and third baffle quadrants are the same size, an the second and fourth baffle quadrants are the same size, but different than that of the first and third baffle quadrants.

With continued reference to FIG. 11, the discharge pipeline 318 includes a first end 328 that is positioned within interior chamber 56 and a second end 330 is exterior the outer surface of cylindrical sidewall 46. Second end 330 of discharge pipeline 318 is connected in fluid communication with the valve 130 which is in fluid communication with first section 132 of the combining junction 374.

In this particular embodiment, sand separator 310 includes a terminal end 332 of pipeline 72 that is positioned vertically above midline 312. This is different than sand separator 10 in which the combining junction 374 was positioned adjacent the lower end of sand separator 10. In sand separator 310, the combining junction 374 is positioned vertically above midline 312 such that the terminal end 332 of pipeline 72 joins second section 134 of combining junction 74 above the opening 324. Recall in sand separator 10, combining junction 74 was below the opening to the discharge tube.

In operation, sand separator 310 receives the fuel stream coming into the sand separator similar to that of sand separator 10 and sand separator 210. Particularly, the fuel stream moves through inlet 26 and is tangentially moved along the inner surface of cylindrical sidewall 46 to contact first plate 34 prior to contacting any other portion of cylindrical sidewall 46. The tangential movement along arcuate plate 34 creates a spiraling effect of the fluid fuel stream enabling gas to be separated therefrom and discharged through first outlet 30 along pipeline 72. With the gaseous fossil fuel separated and exiting through first outlet 30, the sand and fluid mixture spirals downward over and around uptake tube 316 and passing through one of the baffle quadrants 326a-326d. The fluid and sand mixture is contained in the sand containment area 102 and the fluid rises upwardly such that the fluid enters the uptake tube 316 through the bottom opening 324. The heavier sand components remain trapped in the lower portion of the sand separator, particularly in sand containment area 102. As the fluid rises, it moves upwardly through uptake tube 316 where the fluid separated from the sand may then discharge outwardly from the vessel body through pipeline 318 towards the combining junction 374.

The baffles 320a operate to reduce turbulent forces as the fluid and sand mixture is falling and passing through the baffle quadrants 326a-326d. Thus, the baffles serve two functions, to structurally support uptake tube 316 in the center of interior chamber 56 as well as to reduce turbulent fluid forces occurring inside the interior chamber 56 as the tangentially moving fuel stream is spiraling downward from above.

In an exemplary and non-limiting aspect, one embodiment of the disclosure may provide a sand separator for fossil fuel processing comprising: an elongated cylindrical body extending centrally along a longitudinal axis and wherein the longitudinal axis is aligned directly vertical; an outer surface and inner surface, wherein the inner surface defines a containing volume; an inlet in fluid communication with the containing volume, the inlet position adjacent an upper end of the cylindrical body having a fluid mixture flow therethrough into the containing volume, wherein the fluid mixture includes gaseous fossil fuel, liquid water, and sand; a first rigid member secured to the inner surface and extending inwardly towards the longitudinal axis, wherein the first rigid member is an arcuate plate having first and second surfaces and the first surface having a radius of curvature complementary to that of the inner surface, and having a lower terminal edge; the first rigid member positioned adjacent the inlet such that fluid carrying fossil fuel through the inlet contacts the first rigid member before contacting the inner surface; wherein the inlet is offset from the longitudinal axis and tangentially aligned with the inner surface such that fluid moving through the inlet and contacting the first rigid member moves in a spiraling manner about the longitudinal axis while moving along the inner surface and simultaneously being drawn downward under gravitational forces; a second rigid member connected to the inner surface, and the second rigid member having an arcuate upper edge including an apex disposed at a height lower than the lower terminal edge of the first rigid member and wherein the entire arcuate upper edge is connected with the inner surface, and when viewed in cross section the second rigid member is angled relative to horizontal and extends downwardly to a lower edge at a first angle in a range from about 20 degrees to about 80 degrees; a third rigid member connected to the inner surface, and the third rigid member having an arcuate upper edge including an apex disposed at a height above the lower edge of the second rigid member, and when viewed in cross section the third rigid member is angled relative to horizontal and extends downwardly to a third rigid member lower edge at a second angle in a range from about 20 degrees to about 80 degrees, and wherein the first and second angles are within 10 degrees relative to each other; a gas outlet in fluid communication with adjacent its top and the containing volume configured to release the gaseous fossil fuel, wherein the gas outlet positioned above the inlet; a fluid outlet disposed within the containing volume interior and offset from the inner surface and beneath the third rigid member, wherein the fluid outlet faces vertically upwards to allow fluid to raise upwardly in the containing volume and spill over the fluid outlet and drain vertically downward through a pipe after the fluid has been separated from the sand; a sand containment area defining a bottom of the containing volume; a sand outlet in fluid communication with the sand containment area configured to drain sand from the bottom of the containing volume after the sand has been separated from the gaseous fossil fuel and the liquid water; a recombination area defied by a combining junction exterior to the cylindrical body fluidly connected with the fluid outlet and the gas outlet combining gaseous fossil fuel with liquid water.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

What is claimed:

1. A sand separator for fossil fuel processing comprising:
an elongated cylindrical body extending centrally along a longitudinal axis;
an outer surface and inner surface on the cylindrical body, wherein the inner surface defines a containing volume;
a sand containment area associated with one end of the containing volume; and
an inlet aligned tangentially relative to the inner surface and the inlet in fluid communication with the containing volume such that a fluid mixture carrying fossil fuel moving through the inlet enters the containing volume moving in a tangential direction relative to the inner surface.

2. The sand separator of claim 1, further comprising:
a vertical alignment of the longitudinal axis;
a top end positioned above a bottom end; and
wherein the inlet is positioned adjacent the top end and vertical alignment causes the fluid to spiral downwardly under gravitational forces after the fluid enters the containing volume in a tangential direction relative to the inner surface.

3. The sand separator of claim 1, further comprising an arcuate first plate attached to the inner surface positioned adjacent the inlet.

4. The sand separator of claim 3, wherein the fluid comprises a mixture of sand fed through the inlet and the fluid moving in the tangential direction contacts the arcuate plate before contacting the inner surface of the cylindrical body.

5. The sand separator of claim 3, wherein the arcuate plate comprises first and second surfaces and the first surface having a radius of curvature complementary to that of the inner surface.

6. The sand separator of claim 5, wherein the arcuate plate further comprises a lower terminal edge, wherein the inlet is positioned entirely above the lower terminal edge.

7. The sand separator of claim 3, further comprising a gas carrying first outlet positioned at a height above the arcuate plate.

8. The sand separator of claim 3, further comprising:
a second plate positioned beneath the arcuate first plate, wherein the second plate is rigidly secured to the inner surface of the cylindrical body.

9. The sand separator of claim 8, wherein the second plate is positioned at an angle relative to horizontal in a range from 20 degrees to 80 degrees, the second plate comprising:
a parabolically-shaped top edge rigidly connected to the inner surface along its entire length.

10. The sand separator of claim 9, further comprising:
a third plate disposed beneath the second plate defining a gap therebetween;
the third plate is positioned at an angle relative to horizontal in a range from 20 degrees to 80 degrees; and
wherein the angle associated with the third plate is within 10 degrees of the angle associated with the second plate.

11. The sand separator of claim 1, further comprising:
a fluid outlet assembly including outlet pipeline disposed within the containing volume and extending outwardly through the cylindrical body, and a portion of the outlet pipeline defining an opening for fluid to exit the containing volume, wherein the opening is positioned above a vertical midline of the cylindrical body.

12. The sand separator of claim 11, wherein fluid outlet assembly further includes an uptake tube centered within the containing volume, wherein a lowermost end of the uptake tube defines the opening to the fluid outlet.

13. The sand separator of claim 12, further comprising:
at least one baffle extending between the uptake tube and the inner surface of the cylindrical body.

14. The sand separator of claim 13, further comprising:
at least two baffles spaced at equal angular intervals, wherein the at least two baffles are rigidly secured to the uptake tube and the inner surface of the cylindrical body and the uptake tube is centered within the containing volume.

15. The sand separator of claim 11, wherein the opening to the outlet pipeline is positioned above the sand containment area and the pipeline extends through the sand containment area prior to exiting the cylindrical body.

16. The sand separator of claim 1, further comprising:
a liquid outlet assembly for removing liquid from the sand separator after fossil fuel and sand has been separated from the fluid mixture that entered the containing volume moving in a tangential direction relative to the inner surface;
a gas outlet for removing fossil fuel from the sand separator after the fossil fuel has been separated from the fluid mixture; and
a combining junction exterior the outer surface of the cylindrical body wherein the fossil fuel is mixed with the liquid free of sand and other solids.

17. A method of separating sand from gaseous fossil fuel in a sand separator comprising the steps of:
moving a fluid mixture comprising a fossil fuel, sand, and a liquid along a pipeline towards a sand separator including an arcuate inner surface defining an internal containing volume;
effecting the fluid mixture to enter the containing volume at a tangential direction relative to the inner surface; and
spiraling the liquid and sand downwardly along the inner surface and simultaneously releasing fossil fuel upwardly in a substantially gaseous state.

18. The method of claim 17, further comprising the steps of:
filling the containing volume with an amount of liquid and sand;
increasing the liquid until the amount of liquid exceeds a threshold prescribed by an outlet opening position and size; and
effecting liquid separated from sand to exit the containing volume through the outlet opening.

19. The method of claim 18, wherein the step of effecting liquid separated from sand to exit the containing volume through the outlet opening is accomplished by only one of the following:
(i) exiting through an uptake tube centered in the containing volume by a plurality of baffles, and an uptake tube opening is the lowermost portion of an outlet assembly; and
(ii) exiting through a vertically aligned outlet pipeline disposed in the containing volume, and an outlet pipeline opening is the uppermost portion of an outlet assembly.

20. A sand separator for fossil fuel processing comprising:
an elongated cylindrical body extending centrally along a longitudinal axis and wherein the longitudinal axis is vertically aligned;
an outer surface and inner surface of the cylindrical body, wherein the inner surface defines a containing volume;
an inlet in fluid communication with the containing volume, the inlet position adjacent an upper end of the cylindrical body, wherein a fluid mixture flows through the inlet into the containing volume, and wherein the fluid mixture includes gaseous fossil fuel, liquid water, and sand;
wherein the inlet is offset from the longitudinal axis and tangentially aligned with the inner surface of the cylindrical body such that fluid moving through the inlet moves in a spiraling motion about the longitudinal axis while moving along the inner surface and simultaneously being drawn downward under gravitational forces;
a first rigid member secured to the inner surface and extending inwardly towards the longitudinal axis, wherein the first rigid member is an arcuate plate having first and second surfaces and the first surface having a radius of curvature complementary to that of the inner surface, and having a lower terminal edge;
the first rigid member positioned adjacent the inlet such that the fluid mixture carrying fossil fuel through the inlet contacts the first rigid member before contacting the inner surface;
a gas outlet in fluid communication with the containing volume adjacent its top and configured to release the gaseous fossil fuel, wherein the gas outlet positioned above the inlet;
a fluid outlet assembly at least partially disposed within the containing volume, wherein the fluid outlet assembly enables fluid to raise upwardly in the containing volume and exit the through an opening to drain through a pipe after the fluid has been separated from the sand;
a sand containment area defining a bottom of the containing volume;
a sand outlet in fluid communication with the sand containment area configured to drain sand from the bottom of the containing volume after the sand has been separated from the gaseous fossil fuel and the liquid water;
a recombination area defined by a combining junction exterior to the cylindrical body fluidly connected with the fluid outlet assembly and the gas outlet configured to combine and mix gaseous fossil fuel with liquid water.
